(19) United States
(12) Patent Application Publication
(10) Pub. No.: US 2026/0064105 A1
(43) Pub. Date: Mar. 5, 2026

(54) Multi-Unit Remote Monitoring and Control System with AI and Non-AI Modes for Industrial Environments

(71) Applicant: Xinxin Shan, Surrey (CA)

(72) Inventor: Xinxin Shan, Surrey (CA)

(73) Assignee: LED Smart Inc, Surrey, BC (CA)

(21) Appl. No.: 18/822,002

(22) Filed: Aug. 30, 2024

(51) Int. Cl. G05B 19/418; H04L 9/40

(52) U.S. Cl. CPC G05B 19/4185; H04L 63/06

(57) ABSTRACT

The present invention relates to a multi-unit remote monitoring and control system designed specifically for industrial environments, capable of operating in AI, non-AI, and dual AI/non-AI modes. The system dynamically manages communication across various industrial protocols, optimizes energy usage through energy harvesting, and ensures robust security with multi-layered encryption and blockchain technology. The system includes a dynamic communication module that switches between industrial protocols, a mesh or hybrid network supporting industrial-grade wireless communication, and a user interface for remote monitoring and control. AI integration allows for advanced analytics and predictive maintenance, making the system adaptable to diverse industrial applications.

### CROSS-REFERENCE TO RELATED APPLICATIONS

US PATENT DOCUMENTS

| | |
|---|---|
| 20050182847 A1 | August 2005 Jawad Pirzada |
| 20230344270 A1 | October 2023 van der Velden |
| 9,335,748 B2 | May 2016 Francino |
| 11,188,065 B2 | November 2021 Vedula |
| 9,779,229 B2 | October 2017 Rooyakkers |
| 7,468,661 B2 | December 2008 Petite |
| 20190132023 A1 | May 2019 Tokgoz |

### OTHER PUBLICATION

Hu B. et al, “A Hybrid Wired/Wireless Deterministic Network for Smart Grid,” in IEEE Wireless Communications, vol. 28, no. 3, pp. 138-143, June 2021, doi: 10.1109/MWC.001.2000493.
Khan, B. U. I. et al, “Integrating AI and Blockchain for Enhanced Data Security in IoT-Driven Smart Cities”. Processes 2024, 12, 1825. https://doi.org/10.3390/pr12091825.
Liao, Z. et al, “AR-enhanced digital twin for human-robot interaction in manufacturing systems. Energ. Ecol. Environ. (2024). https://doi.org/10.1007/s40974-024-00327-7

### BACKGROUND OF THE INVENTION

The need for reliable and efficient remote monitoring and control systems in industrial environments has grown significantly with the rise of automation and the Industrial Internet of Things (IIoT). Traditional systems often struggle with issues such as protocol compatibility, energy inefficiency, and security vulnerabilities. Existing solutions, especially those designed for general consumer wireless communication, do not adequately address the unique and complex requirements of industrial communication networks, which often involve multiple specialized protocols. The present invention addresses these challenges by providing a comprehensive solution specifically designed for industrial environments, integrating both AI and non-AI modes, supporting a diverse array of industrial communication protocols, optimizing energy use, and ensuring secure data transmission.

### SUMMARY OF THE INVENTION

The invention provides a multi-unit remote monitoring and control system tailored for industrial environments. The system is versatile, offering AI and non-AI operational modes and supporting a wide range of industrial communication protocols. The system optimizes energy management, ensures robust security, and dynamically manages communication within complex industrial environments.

### BRIEF DESCRIPTION OF DRAWINGS

FIG. 1: System Architecture Overview

FIG. 2: Dynamic Communication Module

FIG. 3: AI Processing Module

FIG. 4: Energy Management System

FIG. 5: Security Module

FIG. 6: Mesh/Hybrid Network Configuration

FIG. 7: User Interface Configuration

### DETAILED DESCRIPTION OF THE INVENTION

The present invention relates to a multi-unit remote monitoring and control system designed to function effectively in industrial environments characterized by harsh conditions, including high levels of electromagnetic interference, extreme temperatures, and the need for continuous operation. The system consists of multiple control units distributed throughout the industrial facility, each equipped with communication interfaces capable of supporting various industrial protocols, ensuring seamless integration with existing industrial systems and devices.

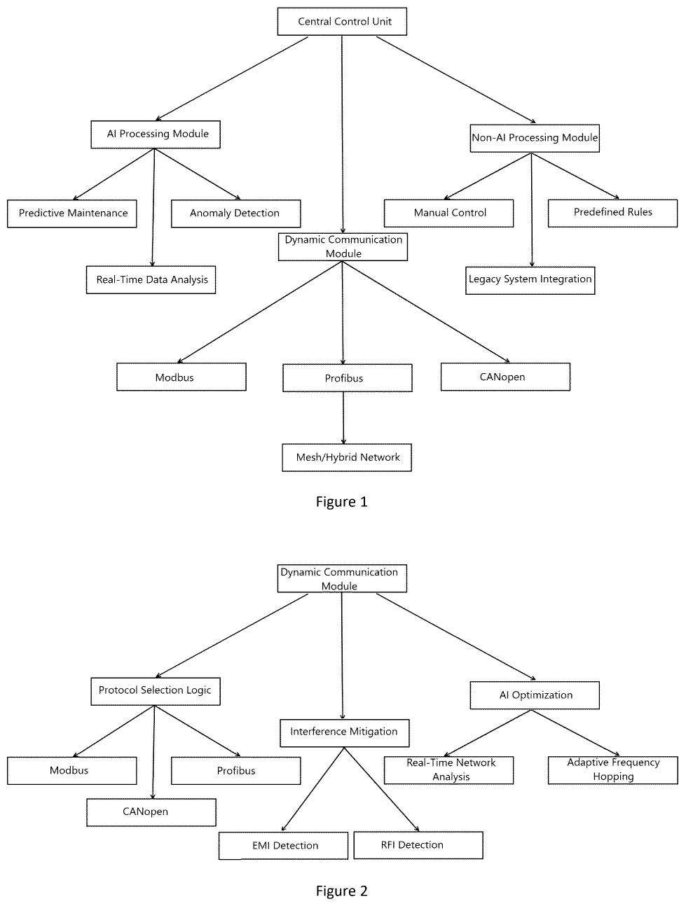

Referring to FIG. 1, the system's architecture is modular, allowing for easy expansion as the industrial facility's needs grow. Each control unit is capable of operating independently or in coordination with other units, providing flexibility in deployment and operation.

The system includes two distinct operational modes: AI and non-AI. In AI mode, the system leverages machine learning algorithms to perform tasks such as predictive maintenance, anomaly detection, and real-time data analysis. These capabilities enable the system to anticipate potential failures, optimize maintenance schedules, and improve overall operational efficiency. In non-AI mode, the system operates in a traditional manner, relying on predefined rules and manual control inputs. This mode is ideal for applications where AI capabilities are not required or where the system is integrated into legacy industrial systems that do not support AI. The switchable operation module allows for easy transitioning between AI and non-AI modes, depending on the specific requirements of the industrial environment. This flexibility ensures that the system can adapt to a wide range of use cases and operational conditions.

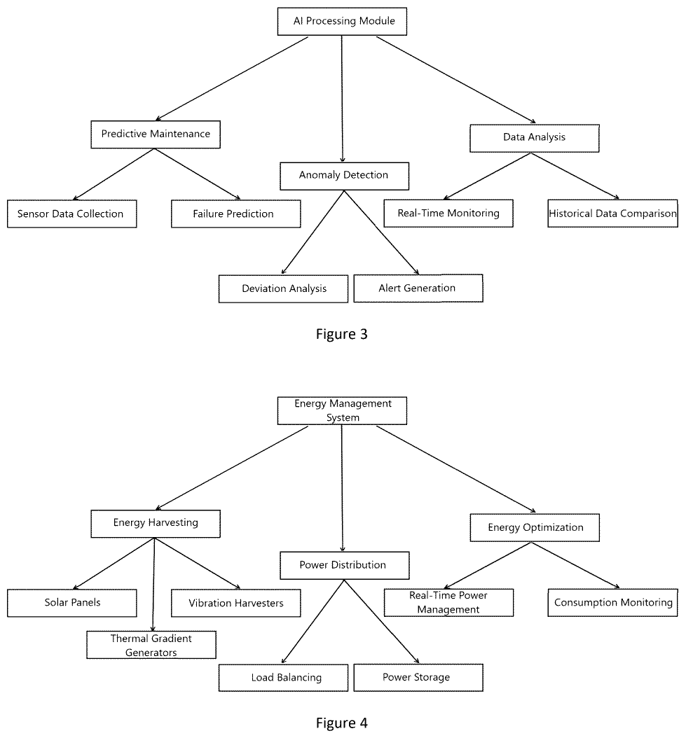

Referring to FIG. 2, the dynamic communication module is a key component of the system, enabling it to manage communication across multiple industrial protocols. This module is specifically designed for industrial environments, where reliable communication is critical to maintaining operational efficiency and safety. The module continuously monitors network conditions and dynamically switches between protocols based on factors such as signal strength, interference levels, and data throughput requirements. This capability ensures that the system can maintain reliable communication even in challenging environments where traditional wireless communication systems may struggle. The communication module is also equipped with advanced interference mitigation features, designed to reduce the impact of electromagnetic interference (EMI) and radio frequency interference (RFI) commonly encountered in industrial settings. These features include adaptive frequency hopping, error correction algorithms, and signal amplification, all of which contribute to the system's robust communication performance.

Referring to FIG. 3, the AI Processing Module is a critical component of the system, enabling advanced data analysis and decision-making capabilities. This module leverages machine learning algorithms to perform tasks such as predictive maintenance, anomaly detection, and real-time data analysis. The AI Processing Module continuously learns from the data it processes, improving its accuracy and efficiency over time. This capability allows the system to anticipate potential failures, optimize maintenance schedules, and enhance overall operational efficiency. The AI Processing Module is designed to work seamlessly with the system's other components, ensuring that AI-driven insights are effectively integrated into the system's operations.

Referring to FIG. 4, energy efficiency is a critical concern in industrial environments, where power consumption can have a significant impact on operational costs. The system's energy management system is designed to optimize power usage, ensuring that the system operates efficiently while minimizing its environmental footprint. The energy management system includes energy harvesting capabilities, allowing the system to draw power from environmental sources such as solar energy, vibration, and thermal gradients. This feature reduces the system's reliance on external power supplies, making it more resilient in environments where power availability may be limited or unreliable. In addition to energy harvesting, the system includes power management algorithms that optimize the distribution and consumption of energy across the control units. These algorithms take into account factors such as workload, communication requirements, and environmental conditions to ensure that energy is used efficiently and that the system remains operational under all circumstances.

Referring to FIG. 5, security is a paramount concern in industrial environments, where the potential for cyberattacks and data breaches can have serious consequences. The system includes a comprehensive security module that provides multi-layered protection against a wide range of threats. The security module incorporates blockchain technology, which provides a decentralized and tamper-resistant ledger for storing and verifying data. This technology ensures that data transmitted across the system is secure and that any attempts to alter or corrupt the data are quickly detected and prevented. In AI mode, the security module also includes AI-enhanced threat detection capabilities. These capabilities allow the system to identify and respond to potential threats in real time, providing an additional layer of protection against cyberattacks. The AI algorithms used for threat detection are continuously updated based on new threat intelligence, ensuring that the system remains protected against emerging threats.

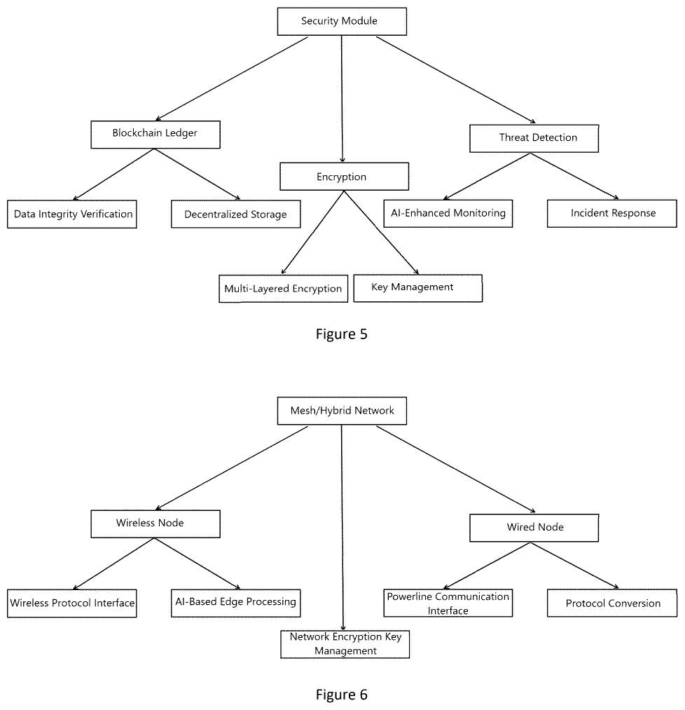

Referring to FIG. 6, the system's communication network is based on a mesh or hybrid architecture, which provides several advantages in industrial environments. In a mesh network, each node (control unit) can communicate with any other node in the network, providing multiple pathways for data transmission. This architecture ensures that the network remains operational even if individual nodes fail or if communication pathways are disrupted. The hybrid network option allows the system to combine different communication technologies, such as wireless mesh networking and powerline communication, to further enhance reliability and performance. This flexibility allows the system to adapt to the specific communication needs and challenges of the industrial environment in which it is deployed. The network is designed to support industrial-grade wireless protocols, which are distinct from consumer wireless protocols. These industrial protocols are specifically engineered to handle the demands of industrial environments, including high data throughput, low latency, and resistance to interference. The network is also equipped with unique encryption keys for each mesh or hybrid network, ensuring that communication within the network is secure and that multiple networks can operate simultaneously without interference.

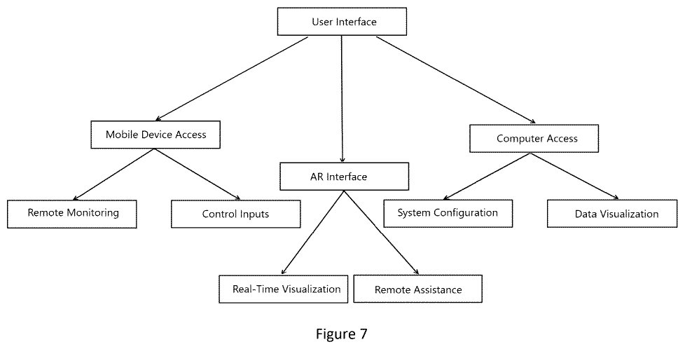

Referring to FIG. 7, the User Interface Configuration is designed to provide an intuitive and user-friendly experience for operators. The user interface includes customizable dashboards that display real-time data and system status, allowing operators to monitor and control the system effectively. The interface supports various input methods, including touchscreens, keyboards, and voice commands, providing flexibility in how operators interact with the system. Additionally, the user interface includes advanced visualization tools, such as graphs and charts, to help operators understand complex data and make informed decisions. The User Interface Configuration is designed to be accessible from multiple devices, including desktops, tablets, and smartphones, ensuring that operators can manage the system from anywhere.

The invention described in this patent application provides a comprehensive and adaptable solution for remote monitoring and control in industrial environments. By integrating AI and non-AI operational modes, a dynamic communication module, advanced energy management, and robust security features, the system is well-suited to meet the complex and evolving needs of modern industrial facilities. The invention's ability to dynamically manage communication across multiple industrial protocols, coupled with its energy-efficient design and enhanced security, distinguishes it from existing solutions and ensures its relevance in a wide range of industrial applications. The system's modular architecture and flexible operational modes make it a valuable tool for improving operational efficiency, reducing downtime, and enhancing the overall safety and reliability of industrial processes.

1. A non-AI multi-unit remote monitoring and control system for industrial environments comprising:
At least two control units, each equipped with one or more communication interfaces supporting a plurality of industrial protocols including Modbus, Profibus, DeviceNet, EtherNet/IP, CANopen, PROFINET, BACnet, DNP3, HART, 0-10V, 4-20 mA and DALI;
A dynamic communication module specifically configured to switch between these industrial protocols based on network conditions in industrial environments;
A user interface configurable via mobile devices or computers through wireless or wired connections, optimized for industrial control;
A mesh or hybrid network of wireless nodes, each node capable of communicating with other nodes and the control units, supporting industrial-grade wireless protocols, distinct from consumer wireless protocols like 802.11a/b/g;
An energy management system featuring energy harvesting from environmental sources, optimized for industrial use.

2. The system of claim 1, wherein the mesh or hybrid network is configured with its own unique encryption key, allowing multiple networks to operate simultaneously or individually, ensuring secure communication across the system.

3. The system of claim 1, further comprising a local server or cloud system for processing and storing data transmitted and received by the control units.

4. The system of claim 1, wherein the communication module includes interference mitigation features specifically designed for industrial environments, managing and reducing the impact of wireless interference sources such as electromagnetic interference (EMI) and radio frequency interference (RFI).

5. A multi-unit remote monitoring and control system with AI operation mode for industrial environments comprising:
At least two control units, each equipped with an AI processing module for performing predictive maintenance, anomaly detection, and real-time data analysis in AI mode;
A dynamic communication module specifically configured to switch between industrial communication protocols, optimized by AI algorithms based on real-time network performance data within industrial environments;
A security module incorporating multi-layered encryption and blockchain technology for data protection, with AI-enhanced threat detection in AI mode;
An optional AR interface in AI mode for enhanced data visualization and remote assistance in industrial processes;
A mesh or hybrid network of wireless nodes, each capable of performing AI-based edge processing in AI mode, optimized for industrial protocols and environments.

6. The system of claim 5, wherein the AI processing module includes machine learning algorithms tailored to optimize network performance and energy management based on real-time data analytics from industrial environments.

7. The system of claim 5, further comprising a local server or cloud system for processing and storing data transmitted and received by the control units.

8. The system of claim 5, wherein the communication module is capable of dynamically interfacing with either local server or cloud systems, allowing for flexible and scalable data management solutions in industrial contexts.

9. A multi-unit remote monitoring and control system with dual AI/non-AI operation modes for industrial environments comprising:
At least two control units, each equipped with one or more communication interfaces supporting a plurality of industrial protocols including Modbus, Profibus, DeviceNet, Ether Net/IP, CANopen, PROFINET, BACnet, DNP3, HART, 0-10V, 4-20 mA and DALI;
A switchable operation module that allows the system to operate in either AI mode or non-AI mode, specifically tailored for industrial environments;
A dynamic communication module configured to switch between industrial communication protocols based on network conditions, with AI optimizations in AI mode;
An energy management system featuring energy harvesting from environmental sources, optimized for industrial use;
A mesh or hybrid network of wireless nodes, each node capable of communicating with other nodes and the control units, supporting industrial-grade wireless protocols distinct from general consumer wireless protocols;
A security module incorporating multi-layered encryption and blockchain technology, with AI-enhanced threat detection in AI mode;
An optional AR interface for real-time data visualization and remote assistance, available in AI mode.

10. The system of claim 9, wherein the AI processing module includes machine learning algorithms tailored to optimize network performance and energy management based on real-time data analytics from industrial environments.

11. The system of claim 9, further comprising a local server or cloud system for processing and storing data transmitted and received by the control units.

12. The system of claim 9, wherein the mesh or hybrid network is configured with its own unique encryption key, allowing multiple networks to operate simultaneously or individually, ensuring secure communication across the system.

13. The system of claim 9, wherein the communication module includes interference mitigation features specifically designed for industrial environments, managing and reducing the impact of wireless interference sources such as electromagnetic interference (EMI) and radio frequency interference (RFI).
